(19) United States
(12) Patent Application Publication
(10) Pub. No.: US 2024/0313566 A1
(43) Pub. Date: Sep. 19, 2024

(54) CHARGING/DISCHARGING POWER CONVERSION SYSTEM AND AUXILIARY CURRENT CONTROL CIRCUIT AND CONTROL METHOD THEREOF

(71) Applicant: Richtek Technology Corporation, Zhubei City (TW)

(72) Inventors: Ping-Fan Wang, Hsinchu (TW); Po-Chen Liu, Hsinchu (TW); Jui-Cheng Yang, New Taipei (TW); Hung-Chi Chen, Hsinchu (TW)

(21) Appl. No.: 18/492,879

(22) Filed: Oct. 24, 2023

Related U.S. Application Data
(60) Provisional application No. 63/490,673, filed on Mar. 16, 2023.

(30) Foreign Application Priority Data
Jul. 12, 2023 (TW) 112125984

(51) Int. Cl. H02J 7/00

(52) U.S. Cl. CPC H02J 7/00714; H02J 7/0047

(57) ABSTRACT

A charging/discharging power conversion system includes: a current control circuit, wherein a serial connection of a second battery and the current control circuit is connected in parallel to a first battery between a charging node and a reference voltage level; and an auxiliary current control circuit, including: a current measurement circuit measuring a first battery current and generate a battery current signal; and a current adjustment circuit adjusting a charging current according to the battery current signal via an adjustment procedure, to render the first battery current not to be greater than a first battery current threshold; wherein the adjustment procedure includes: setting the first battery current threshold; setting an initial value of the charging current, such that the initial value of the charging current is equal to a sum of the first battery current threshold plus a second battery current threshold.

### CROSS REFERENCE

The present invention claims priority to the U.S. provisional application Ser. No. 63/490,673, filed on Mar. 16, 2023 and claims priority to TW application Ser. No. 112125984, filed on Jul. 12, 2023, all of which foregoing mentioned provisional and nonprovisional patent applications are incorporated herein in their entirety by their reference.

### BACKGROUND OF THE INVENTION

### Field of Invention

The present invention relates to a charging/discharging power conversion system; particularly, it relates to such charging/discharging power conversion system well competent to accomplish an efficacy of balancing a first battery current and a second battery current in a case where such charging/discharging power conversion system does not necessarily to dispose two current control circuits. The present invention also relates to an auxiliary current control circuit and a control method of such charging/discharging power conversion system.

### Description of Related Art

Please refer to FIG. 1, which shows a schematic circuit diagram of a conventional charging/discharging power conversion system. The prior art shown in FIG. 1 has following defect that: in the conventional charging/discharging power conversion system, if each of a first battery 101 and a second battery 102 is degenerated or if an internal resistance of the first battery 101 is different from an internal resistance of the second battery 102, there is a likelihood that a voltage of the first battery 101 is different from (i.e., is inconsistent with) a voltage of the second battery 102, such that a battery balancing will be undesirably unable to occur between a first battery current Ibat1 and a second battery current Ibat2.

Please refer to FIG. 2, which shows a schematic circuit diagram of another conventional charging/discharging power conversion system. The prior art shown in FIG. 2 has following drawback that: the conventional charging/discharging power conversion system shown in FIG. 2 includes two current control circuits 104 and 104, so a space occupied by the conventional charging/discharging power conversion system shown in FIG. 2 is relatively greater and has a relatively greater manufacturing cost.

In view of the above, to overcome the drawbacks in the prior art, the present invention proposes a charging/discharging power conversion system well competent to accomplish an efficacy of balancing a first battery current and a second battery current in a case where such charging/discharging power conversion system does not necessarily to dispose two current control circuits.

### SUMMARY OF THE INVENTION

From one perspective, the present invention provides a charging/discharging power conversion system, which is configured to operably conduct a power conversion between an input power at an input node and a charging power at a charging node, so as to execute an operation of charging or an operation of discharging on a first battery and a second battery; the charging/discharging power conversion system comprising: a current control circuit, wherein a serial connection of the second battery and a current control transistor of the current control circuit is connected in parallel to a first battery between a charging node and a reference voltage level, wherein the current control circuit is configured to operably control a second battery current of a second battery power at a second battery node flowing between the current control circuit and the second battery, such that the second battery current is not greater than a second battery current threshold; and an auxiliary current control circuit including: a current measurement circuit, which is configured to operably measure a first battery current of a first battery power at a first battery node flowing between the charging node and the first battery, and the current measurement circuit is configured to operably generate a battery current signal; and a current adjustment circuit, which is configured to operably adjust a charging current of the charging power according to the battery current signal via an adjustment procedure, so that the first battery current is not greater than a first battery current threshold; wherein the adjustment procedure includes following steps: setting the first battery current threshold by the current adjustment circuit; setting an initial value of the charging current by the current adjustment circuit, such that the initial value of the charging current is equal to a sum of the first battery current threshold plus the second battery current threshold; and adjusting the charging current based upon the first battery current and the first battery current threshold by the current adjustment circuit, such that the first battery current is not greater than the first battery current threshold; wherein the charging node is coupled to the first battery node, whereas, the charging node is coupled to the second battery node via the current control circuit.

From another perspective, the present invention provides an auxiliary current control circuit, which is configured to operably control a charging current of a charging power at a charging node in a charging/discharging power conversion system, thereby controlling a first battery current of a first battery power at a first battery node, wherein the charging/discharging power conversion system is configured to operably conduct a power conversion between an input power at an input node and the charging power at the charging node; the auxiliary current control circuit comprising: a current measurement circuit, which is configured to operably measure a first battery current of a first battery power at a first battery node flowing between the charging node and the first battery, and the current measurement circuit is configured to operably generate a battery current signal; and a current adjustment circuit, which is configured to operably adjust a charging current of the charging power according to the battery current signal via an adjustment procedure, so that the first battery current is not greater than a first battery current threshold; wherein the adjustment procedure includes following steps: setting the first battery current threshold by the current adjustment circuit; setting an initial value of the charging current by the current adjustment circuit, such that the initial value of the charging current is equal to a sum of the first battery current threshold plus the second battery current threshold; and adjusting the charging current based upon the first battery current and the first battery current threshold by the current adjustment circuit, such that the first battery current is not greater than the first battery current threshold; wherein the charging current is equal to a sum of the first battery current plus the second battery current.

In one embodiment, the current adjustment circuit is configured to operably adjust the charging current according to the first battery current as well as the first battery current threshold through executing a linear search algorithm or a binary search algorithm, so that the first battery current is not greater than the first battery current threshold.

In one embodiment, the adjustment procedure further comprises following steps: adjusting the charging current back to the initial value of the charging current by the current adjustment circuit when the input power is absent.

In one embodiment, in a case when a first battery voltage of the first battery power is smaller than a second battery voltage of the second battery power, the current control circuit is configured to operably control the current control transistor, such that the second battery current is not smaller than zero.

In one embodiment, the current control circuit is independent from the auxiliary current control circuit.

In one embodiment, the current measurement circuit includes: an analog-to-digital converter (ADC).

In one embodiment, the ADC is disposed inside a battery capacity gauge integrated circuit (IC).

In one embodiment, the current adjustment circuit includes: a micro control unit (MCU).

In one embodiment, the charging/discharging power conversion system further comprises: a current error amplifier, which is configured to operably adjust the charging current in accordance with a charging current threshold and the charging current, so that the charging current remains at a preset level, wherein the current adjustment circuit is configured to operably adjust the charging current threshold, hence adjusting the charging current.

From yet another perspective, the present invention provides a control method of a charging/discharging power conversion system, which is configured to operably conduct a power conversion between an input power at an input node and a charging power at a charging node; the control method comprising following steps: controlling a second battery current of a second battery power flowing through a second battery node, such that the second battery current is not greater than a second battery current threshold; measuring a first battery current of a first battery power flowing through a first battery node and generating a battery current signal; and adjusting a charging current of the charging power according to the battery current signal via an adjustment procedure, so that the first battery current is not greater than a first battery current threshold; wherein the charging current is equal to a sum of the first battery current plus the second battery current; wherein the adjustment procedure includes following steps: setting the first battery current threshold; setting an initial value of the charging current, such that the initial value of the charging current is equal to a sum of the first battery current threshold plus the second battery current threshold; and adjusting the charging current based upon the first battery current and the first battery current threshold, such that the first battery current is not greater than the first battery current threshold.

In one embodiment, the step of adjusting the charging current based upon the first battery current and the first battery current threshold is executed via a linear search algorithm or a binary search algorithm.

In one embodiment, the adjustment procedure further includes following steps: when the input power is absent, adjusting the charging current back to the initial value of the charging current.

In one embodiment, the control method further comprises following steps: in a case when a first battery voltage of the first battery power is smaller than a second battery voltage of the second battery power, controlling the current control transistor, such that the second battery current is not smaller than zero.

In one embodiment, the step of adjusting the charging current of the charging power according to the battery current signal via the adjustment procedure further comprises following steps: adjusting the charging current in accordance with a charging current threshold and the charging current, so that the charging current remains at a preset level; and adjusting the charging current threshold, hence adjusting the charging current.

Merit of the present invention lies in that: it is not necessarily for the charging/discharging power conversion system of the present invention to dispose two current control circuits, so that the present invention is well competent to accomplish an efficacy of saving space and an efficacy of reducing manufacturing cost.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic circuit diagram of a conventional charging/discharging power conversion system.

FIG. 2 shows a schematic circuit diagram of another conventional charging/discharging power conversion system.

FIG. 3 shows a schematic circuit diagram of a charging/discharging power conversion system according to an exemplary embodiment of the present invention.

FIG. 4 illustrates signal waveform diagrams depicting signals associated with the operation of a charging/discharging power conversion system of FIG. 3 according to an exemplary embodiment of the present invention.

FIG. 5 illustrates a flow chart diagram of an adjustment procedure depicting operational steps for a current adjustment circuit of a charging/discharging power conversion system according to an exemplary embodiment of the present invention.

FIG. 6 illustrates a flow chart diagram of an adjustment procedure depicting operational steps for a current adjustment circuit of a charging/discharging power conversion system according to another exemplary embodiment of the present invention.

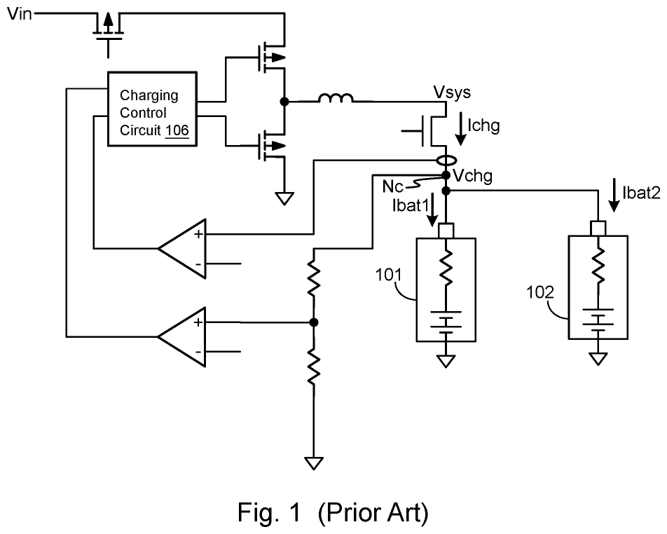

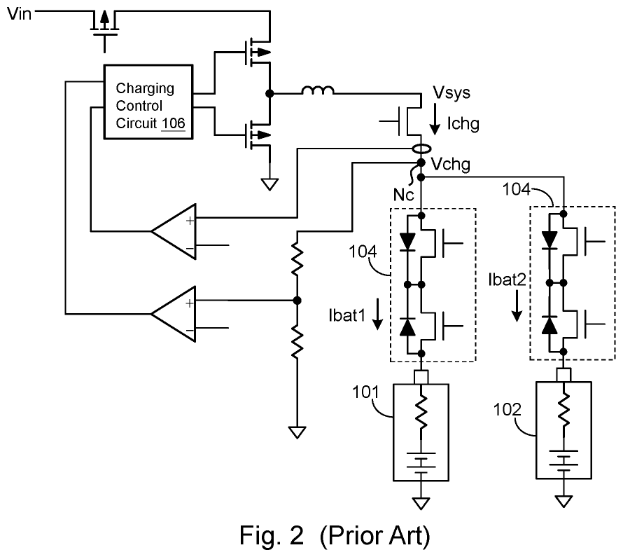

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

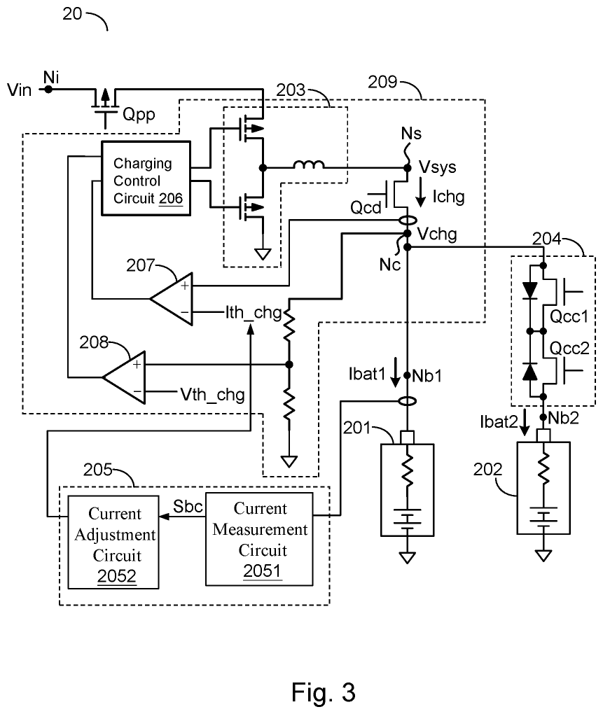

FIG. 3 shows a schematic circuit diagram of a charging/discharging power conversion system according to an exemplary embodiment of the present invention. As shown in FIG. 3, the charging/discharging power conversion system 20 of the present invention is configured to operably conduct a power conversion between an input power at an input node N1 and a charging power at a charging node Nc, so as to execute an operation of charging or an operation of discharging on a first battery 201 and a second battery 202. In one embodiment, the charging/discharging power conversion system 20 comprises: a power path switch Qpp, a power stage circuit 203, a charging/discharging control switch Qcd, a current control circuit 204, an auxiliary current control circuit 205, a charging control circuit 206, a current error amplifier 207 and a voltage error amplifier 208.

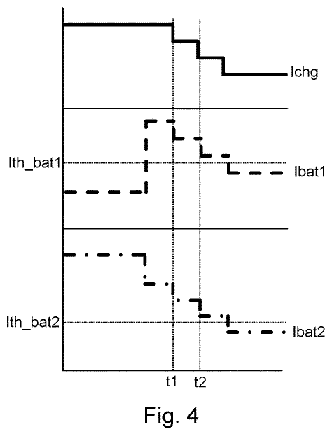

As shown in FIG. 3, the power path switch Qpp is coupled between the input power and the power stage circuit 203. The power stage circuit 203 is, for example but not limited to, a buck circuit shown in FIG. 3. The power stage circuit 203 is configured to operably operate plural switches in the power stage circuit 203 based upon each switch operation signal corresponding to each corresponding switch, so as to convert an input voltage Vin of the input power to a system voltage Vsys of a system power at a system node Ns. One end of the charging/discharging control switch Qcd and the power stage circuit 203 are coupled to the system node Ns, whereas, another end of the charging/discharging control switch Qcd is coupled to the charging node Nc. A serial connection of the second battery 202 and current control transistors Qcc1 and Qcc2 of the current control circuit 204 is connected in parallel to a first battery 201 between a charging node Nc and a reference voltage level. The current control circuit 204 is configured to operably control a second battery current Ibat2 of a second battery power at a second battery node Nb2 flowing between the current control circuit 204 and the second battery 202, such that the second battery current Ibat2 is not greater than a second battery current threshold Ith_bat2 (referring to FIG. 4).

Please refer to FIG. 3. The auxiliary current control circuit 205 includes: a current measurement circuit 2051 and a current adjustment circuit 2052. The current measurement circuit 2051 is configured to operably measure a first battery current Ibat1 of a first battery power at a first battery node Nb1 flowing between the charging node Nc and the first battery 201, and the current measurement circuit 2051 is configured to operably generate a battery current signal Sbc. Please refer to FIG. 3 along with FIG. 4. The current adjustment circuit 2052 is configured to operably adjust a charging current Ichg of the charging power according to the battery current signal Sbc via an adjustment procedure, so that the first battery current Ibat1 is not greater than a first battery current threshold Ith_bat1. In one embodiment, the charging node Nc is coupled to the first battery node Nb1, whereas, the charging node Nc is coupled to the second battery node Nb2 via the current control circuit 204.

In one embodiment, the current adjustment circuit 2052 is configured to operably adjust the charging current Ichg according to the first battery current Ibat1 as well as the first battery current threshold Ith_bat1 through executing a linear search algorithm or a binary search algorithm, so that the first battery current Ibat1 is not greater than the first battery current threshold Ith_bat1. As exemplified by FIG. 4 and FIG. 6, at a time point t1, when the current adjustment circuit 2052 determines that the first battery current Ibat1 is greater than the first battery current threshold Ith_bat1, the current adjustment circuit 2052 will render the charging current Ichg to be reduced by a preset level, thus rendering the first battery current Ibat1 and the second battery current Ibat2 to be reduced by a preset level corresponding to the first battery current Ibat1 and by a preset level corresponding to the second battery current Ibat2, respectively. At a time point t2, when the current adjustment circuit 2052 determines that the first battery current Ibat1 is still greater than the first battery current threshold Ith_bat1, the current adjustment circuit 2052 will render the charging current Ichg to be further reduced by the very same preset level, thus rendering the first battery current Ibat1 and the second battery current Ibat2 to be further reduced by the very same preset level corresponding to the first battery current Ibat1 and by the very same preset level corresponding to the second battery current Ibat2, respectively. Note that the foregoing operation mechanism can be executed in same manner on and on until a scenario where the current adjustment circuit 2052 determines that the first battery current t Ibat1 is not greater than the first battery current threshold Ith_bat1. As a result, in this case, the foregoing operation mechanism will be terminated.

When a first battery voltage Vbat1 of a first battery power is smaller than a second battery voltage Vbat2 of a second battery power, the current control circuit 204 is configured to operably control the current control transistors Qcc1 and Qcc2, such that the second battery current Ibat2 is not smaller than zero. As a consequence, in this case, an operation of discharging of the second battery 202 will be disabled, thereby preventing a negative second battery current Ibat2 from flowing to the first battery 201. In one embodiment, the current control circuit 204 is independent from the auxiliary current control circuit 205. In one embodiment, the current measurement circuit includes: an analog-to-digital converter (ADC). In one embodiment, the ADC is disposed inside battery capacity gauge integrated circuit (IC). In one embodiment, the current adjustment circuit 2052 includes: a micro control unit (MCU).

In one embodiment, the current error amplifier 207 is configured to operably adjust the charging current Ichg in accordance with a charging current threshold Ith_chg and the charging current Ichg, so that the charging current Ichg remains at a preset level. The current adjustment circuit 2052 is configured to operably adjust the charging current threshold Ith_chg, hence adjusting the charging current Ichg. In one embodiment, the voltage error amplifier 208 is configured to operably regulate the charging voltage Vchg in accordance with a charging voltage threshold Vth_chg and the charging voltage Vchg via the charging control circuit 206, so that the charging voltage Vchg remains at a preset level. In one embodiment, at least a portion of the auxiliary current control circuit 205 can be disposed inside a charging/discharging power conversion circuit 209. In one embodiment, a current control circuit 204 can be disposed inside the charging/discharging power conversion circuit 209.

FIG. 4 illustrates signal waveform diagrams depicting signals associated with the operation of a charging/discharging power conversion system of FIG. 3 according to an exemplary embodiment of the present invention. A charging current Ichg, a first battery current Ibat1, a second battery current Ibat2, a first battery current threshold Ith_bat1 and a second battery current threshold Ith_bat2 are explicitly illustrated in FIG. 4.

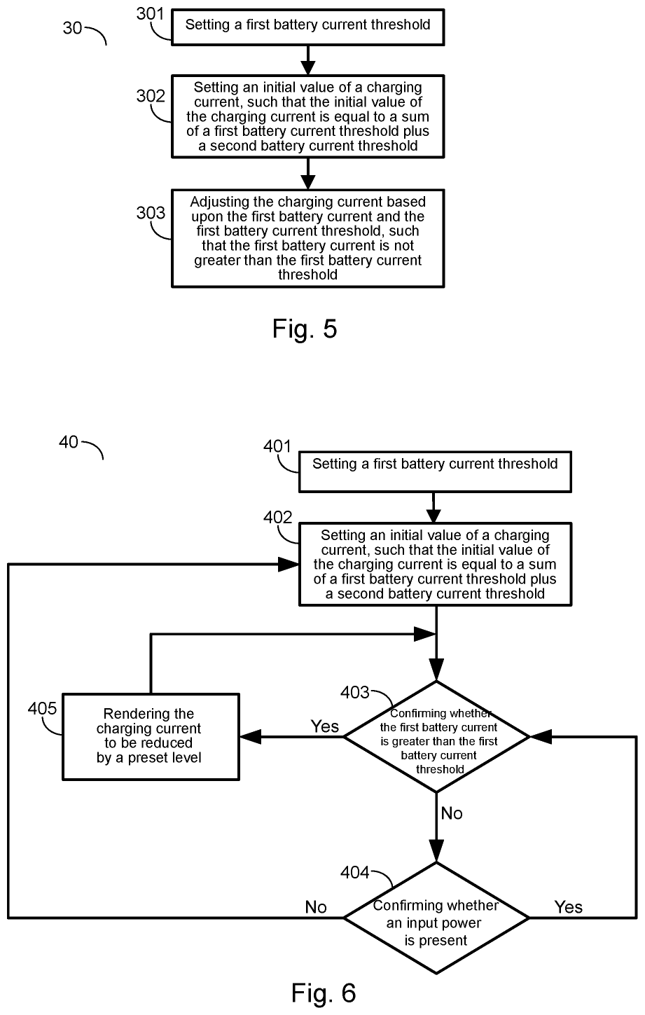

FIG. 5 illustrates a flow chart diagram of an adjustment procedure depicting operational steps for a current adjustment circuit of a charging/discharging power conversion system according to an exemplary embodiment of the present invention. In one embodiment, as shown in FIG. 5, FIG. 4 and FIG. 3, the adjustment procedure 30 includes following steps: in a step 301, which includes: setting the first battery current threshold Ith_bat1 by the current adjustment circuit 2052. Subsequently, in a step 302, which includes: setting an initial value of the charging current Ichg by the current adjustment circuit 2052, such that the initial value of the charging current Ichg is equal to a sum of the first battery current threshold Ith_bat1 plus the second battery current threshold Ith_bat2. Subsequently, in a step 303, which includes: adjusting the charging current Ichg based upon the first battery current Ibat1 and the first battery current threshold Ith_bat1 by the current adjustment circuit 2052, such that the first battery current Ibat1 is not greater than the first battery current threshold Ith_bat1.

FIG. 6 illustrates signal waveform diagrams depicting signals associated with the operation of a charging/discharging power conversion system of FIG. 3 according to an exemplary embodiment of the present invention. In an alternative embodiment, as shown in FIG. 6, FIG. 4 and FIG. 3, the adjustment procedure 40 includes following steps: in a step 401, which includes: setting the first battery current threshold Ith_bat1 by the current adjustment circuit 2052. Subsequently, in a step 402, which includes: setting an initial value of the charging current Ichg by the current adjustment circuit 2052, such that the initial value of the charging current Ichg is equal to a sum of the first battery current threshold Ith_bat1 plus the second battery current threshold Ith_bat2. Subsequently, in a step 403, which includes: confirming whether the first battery current Ibat1 is greater than the first battery current threshold Ith_bat1 by the current adjustment circuit 2052. As shown in FIG. 4 and FIG. 6, at the time point t1, when the current adjustment circuit 2052 determines that the first battery current Ibat1 is greater than the first battery current threshold Ith_bat1 (i.e., it is determined that a result of the step 403 is yes), proceeding to a step 405. The step 405 includes: rendering the charging current Ichg to be reduced by a preset level (for example but not limited to 100 mA) and proceeding back to the step 403. On the other hand, when the current adjustment circuit 2052 determines that the first battery current Ibat1 is smaller than the first battery current threshold Ith_bat1 (i.e., it is determined that a result of the step 403 is no), proceeding to a step 404. The step 404 includes: confirming whether an input power is present. If it is determined that a result of the step 404 is yes, proceeding back to the step 403. If it is determined that a result of the step 404 is no (i.e., when the input power is absent), proceeding back to the step 402. Consequently, in this case, the step 402 includes: adjusting the charging current Ichg back to the initial value of the charging current Ichg by the current adjustment circuit 2052.

As described above, the present invention surpasses and is advantageous over prior art in that: it is not necessarily for the charging/discharging power conversion system of the present invention to dispose two current control circuits, so that the present invention is well competent to accomplish an efficacy of saving space and an efficacy of reducing manufacturing cost.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A charging/discharging power conversion system, which is configured to operably conduct a power conversion between an input power at an input node and a charging power at a charging node, so as to execute an operation of charging or an operation of discharging on a first battery and a second battery; the charging/discharging power conversion system comprising:
a current control circuit, wherein a serial connection of the second battery and a current control transistor of the current control circuit is connected in parallel to a first battery between a charging node and a reference voltage level, wherein the current control circuit is configured to operably control a second battery current of a second battery power at a second battery node flowing between the current control circuit and the second battery, such that the second battery current is not greater than a second battery current threshold; and
an auxiliary current control circuit including:
a current measurement circuit, which is configured to operably measure a first battery current of a first battery power at a first battery node flowing between the charging node and the first battery, and the current measurement circuit is configured to operably generate a battery current signal; and
a current adjustment circuit, which is configured to operably adjust a charging current of the charging power according to the battery current signal via an adjustment procedure, so that the first battery current is not greater than a first battery current threshold;
wherein the adjustment procedure includes following steps:
setting the first battery current threshold by the current adjustment circuit;
setting an initial value of the charging current by the current adjustment circuit, such that the initial value of the charging current is equal to a sum of the first battery current threshold plus the second battery current threshold; and
adjusting the charging current based upon the first battery current and the first battery current threshold by the current adjustment circuit, such that the first battery current is not greater than the first battery current threshold;
wherein the charging node is coupled to the first battery node, whereas, the charging node is coupled to the second battery node via the current control circuit.

2. The charging/discharging power conversion system as claimed in claim 1, wherein the current adjustment circuit is configured to operably adjust the charging current according to the first battery current as well as the first battery current threshold through executing a linear search algorithm or a binary search algorithm, so that the first battery current is not greater than the first battery current threshold.

3. The charging/discharging power conversion system as claimed in claim 1, wherein the adjustment procedure further comprises following steps:
adjusting the charging current back to the initial value of the charging current by the current adjustment circuit when the input power is absent.

4. The charging/discharging power conversion system as claimed in claim 1, wherein in a case when a first battery voltage of the first battery power is smaller than a second battery voltage of the second battery power, the current control circuit is configured to operably control the current control transistor, such that the second battery current is not smaller than zero.

5. The charging/discharging power conversion system as claimed in claim 1, wherein the current control circuit is independent from the auxiliary current control circuit.

6. The charging/discharging power conversion system as claimed in claim 1, wherein the current measurement circuit includes: an analog-to-digital converter (ADC).

7. The charging/discharging power conversion system as claimed in claim 5, wherein the ADC is disposed inside a battery capacity gauge integrated circuit (IC).

8. The charging/discharging power conversion system as claimed in claim 5, wherein the current adjustment circuit includes: a micro control unit (MCU).

9. The charging/discharging power conversion system as claimed in claim 1, further comprising:
a current error amplifier, which is configured to operably adjust the charging current in accordance with a charging current threshold and the charging current, so that the charging current remains at a preset level, wherein the current adjustment circuit is configured to operably adjust the charging current threshold, hence adjusting the charging current.

10. A control method of a charging/discharging power conversion system, which is configured to operably conduct a power conversion between an input power at an input node and a charging power at a charging node; the control method comprising following steps:
controlling a second battery current of a second battery power flowing through a second battery node, such that the second battery current is not greater than a second battery current threshold;
measuring a first battery current of a first battery power flowing through a first battery node and generating a battery current signal; and
adjusting a charging current of the charging power according to the battery current signal via an adjustment procedure, so that the first battery current is not greater than a first battery current threshold;
wherein the charging current is equal to a sum of the first battery current plus the second battery current;
wherein the adjustment procedure includes following steps:
setting the first battery current threshold;
setting an initial value of the charging current, such that the initial value of the charging current is equal to a sum of the first battery current threshold plus the second battery current threshold; and
adjusting the charging current based upon the first battery current and the first battery current threshold, such that the first battery current is not greater than the first battery current threshold.

11. The control method as claimed in claim 10, wherein the step of adjusting the charging current based upon the first battery current and the first battery current threshold is executed via a linear search algorithm or a binary search algorithm.

12. The control method as claimed in claim 10, wherein the adjustment procedure further includes following steps:
when the input power is absent, adjusting the charging current back to the initial value of the charging current.

13. The control method as claimed in claim 10, further comprising following steps:
in a case when a first battery voltage of the first battery power is smaller than a second battery voltage of the second battery power, controlling the current control transistor, such that the second battery current is not smaller than zero.

14. The control method as claimed in claim 10, wherein the step of adjusting the charging current of the charging power according to the battery current signal via the adjustment procedure further comprises following steps:
adjusting the charging current in accordance with a charging current threshold and the charging current, so that the charging current remains at a preset level; and
adjusting the charging current threshold, hence adjusting the charging current.

15. An auxiliary current control circuit, which is configured to operably control a charging current of a charging power at a charging node in a charging/discharging power conversion system, thereby controlling a first battery current of a first battery power at a first battery node, wherein the charging/discharging power conversion system is configured to operably conduct a power conversion between an input power at an input node and the charging power at the charging node; the auxiliary current control circuit comprising:
a current measurement circuit, which is configured to operably measure a first battery current of a first battery power at a first battery node flowing between the charging node and the first battery, and the current measurement circuit is configured to operably generate a battery current signal; and
a current adjustment circuit, which is configured to operably adjust a charging current of the charging power according to the battery current signal via an adjustment procedure, so that the first battery current is not greater than a first battery current threshold;
wherein the adjustment procedure includes following steps:
setting the first battery current threshold by the current adjustment circuit;
setting an initial value of the charging current by the current adjustment circuit, such that the initial value of the charging current is equal to a sum of the first battery current threshold plus the second battery current threshold; and
adjusting the charging current based upon the first battery current and the first battery current threshold by the current adjustment circuit, such that the first battery current is not greater than the first battery current threshold;
wherein the charging current is equal to a sum of the first battery current plus the second battery current.

16. The auxiliary current control circuit as claimed in claim 15, wherein the current adjustment circuit is configured to operably adjust the charging current according to the first battery current as well as the first battery current threshold through executing a linear search algorithm or a binary search algorithm, so that the first battery current is not greater than the first battery current threshold.

17. The auxiliary current control circuit as claimed in claim 15, wherein the adjustment procedure further comprises following steps:
adjusting the charging current back to the initial value of the charging current by the current adjustment circuit when the input power is absent.

18. The auxiliary current control circuit as claimed in claim 15, wherein the current measurement circuit includes: an analog-to-digital converter (ADC).

19. The auxiliary current control circuit as claimed in claim 18, wherein the ADC is disposed inside a battery capacity gauge integrated circuit (IC).

20. The auxiliary current control circuit as claimed in claim 18, wherein the current adjustment circuit includes: a micro control unit (MCU).
